(19) United States
(12) Patent Application Publication
(10) Pub. No.: US 2009/0307570 A1
(43) Pub. Date: Dec. 10, 2009

(54) WORKFLOW PROCESSING APPARATUS AND METHOD

(75) Inventor: Takashi Hirata, Yokohama-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/473,575

(22) Filed: May 28, 2009

(30) Foreign Application Priority Data
Jun. 4, 2008 (JP) 2008-147070

(51) Int. Cl. G06F 15/00; G06Q 10/00

(52) U.S. Cl. 715/200; 705/8

(57) ABSTRACT

A workflow processing apparatus inputs a workflow description document in which a processes to be executed by a workflow have been described, reads data specifying a protocol, which corresponds to a process, from a memory, and executes a process, for which a specific protocol used at the time of execution has not been described in the workflow description document, using the protocol specified by the read data.

### BACKGROUND OF THE INVENTION

1. Field of the Invention

The present invention relates to a workflow processing apparatus and method for processing a workflow.

2. Description of the Related Art

In workflow processing for processing a workflow, which is a flow of a series of steps in an operation or activity, automation is achieved using a computer and a network and operational assistance is rendered in such a manner that information and operations will flow smoothly. For example, by digitizing documents that have circulated in a specific department and among the members of a business and then sending and receiving this information using a computer network, it is possible to make operations proceed more efficiently. Further, workflow processing has come to employ Web service techniques in recent years in addition to a computer and computer network. This has broadened the range of application.

In workflow processing, it is necessary to define beforehand a workflow description document that describes which members information is to be transmitted to and processed by. Further, in workflow processing that has been automated using a computer and network, the workflow processing is implemented by reading the workflow description document into a workflow processing apparatus that is capable of analyzing the document.

In the above-mentioned workflow processing using a computer, a network and a Web service, WS-BELP (Web Services Business Process Execution Language) is being used widely as a language for describing a workflow description document.

The specification of EP1643435 discloses an expandable framework for designing a workflow. In EP1643435, each step has a related component model that describes the mode of a workflow step at the time of design, the mode at the time of compilation and the mode at the time of execution. Furthermore, the developer is capable of expanding a core workflow model by editing these component models. More specifically, activation, execution, query and control functions for a workflow whose execution is in progress can be used and an adhoc dynamic change can be applied to the workflow currently being executed.

However, it is required that the workflow be finalized at the stage where the workflow is described and it is not possible to change processing dynamically at the time of execution.

Further, although it is possible to change workflow processing dynamically at the time of execution according to EP1643435, a protocol that can be handled is of a single type and it is still difficult to apply workflow processing to a device that is equipped with various protocols.

### SUMMARY OF THE INVENTION

The present invention makes it possible to describe a workflow without being aware of the protocol used, convert to a protocol used when workflow processing is performed and then execute processing.

According to one aspect of the present invention, there is provided a workflow processing apparatus comprising: an input unit that inputs a workflow description document in which processes to be executed by the workflow have been described; a reading unit that reads data, which specifies a protocol for executing a process, from the storage unit; and an execution unit that executes a process, for which a specific protocol used at the time of execution has not been described in the workflow description document, using the protocol specified by the data read by the reading unit.

Further features of the present invention will become apparent from the following description of exemplary embodiments with reference to the attached drawings.

### BRIEF DESCRIPTION OF THE DRAWINGS

FIG. 1 is a diagram illustrating an example of the configuration of a workflow processing apparatus according to an embodiment of the present invention;

FIG. 2 is a diagram illustrating an example of an application module executed by the workflow processing apparatus shown in FIG. 1;

FIG. 3 is a diagram illustrating an example of a user interface window in this embodiment;

FIG. 4 is a diagram illustrating an example of a workflow description document 203 converted by a structured-document converter 202 in this embodiment;

FIG. 5 is a diagram illustrating an example of a protocol table 205 contained in a workflow execution unit 204 in this embodiment;

FIGS. 6A and 6B are diagrams illustrating examples of a protocol conversion table 207 contained in a virtual protocol converter 206 in this embodiment;

FIGS. 7A and 7B are flowcharts illustrating virtual protocol processing in this embodiment;

FIG. 8 is a diagram useful in describing execution of an actual protocol by a workflow execution unit; and

FIG. 9 is a diagram useful in describing execution of an actual protocol by a virtual workflow converter.

### DESCRIPTION OF THE EMBODIMENTS

A preferred embodiment for practicing the present invention will now be described in detail with reference to the drawings.

It should be noted that a workflow processing apparatus is not limited to a personal computer and may just as well be a network device such as a work station, notebook personal computer and palm-top personal computer. It may also be a terminal that incorporates a computer, inclusive of an electrical appliance such as a TV, a game machine, telephone, facsimile machine, mobile telephone, PHS or electronic personal organizer. It may also be a combination of these devices.

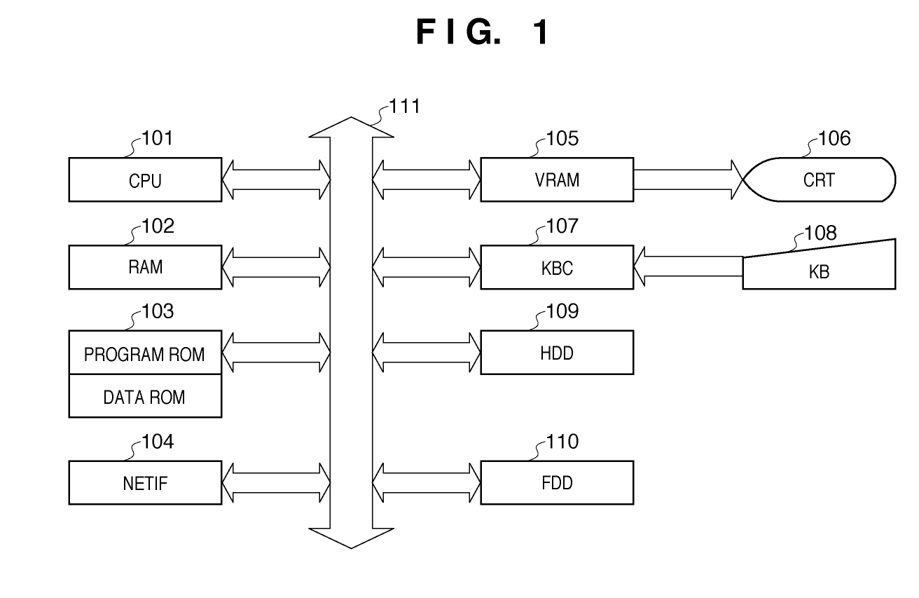

FIG. 1 is a diagram illustrating an example of the configuration of a workflow processing apparatus according to this embodiment. As shown in FIG. 1, a central processing unit (CPU) 101 controls a computer system. A random-access memory (RAM) 102, which serves as the main memory of the CPU 101, functions as an execution program area, a program execution area and a data area. Read-only memories (ROMs) 103 record the operation processing procedure of the CPU 101. The ROMs 103 include a program ROM on which is recorded the basic software (operating system) that is the system program for controlling the devices in the computer system, and a data ROM on which is recorded information, etc., necessary in order to operate the system. There are also cases where a hard-disk drive (HDD) 109, described later, is used instead of the ROM 103.

A network interface (NETIF) 104 implements control for transferring data between computer systems via a network and diagnoses the status of the connection. Further, in a document processing apparatus, the NETIF is not essential but provision of this interface is necessary in a case where a layout rule is acquired from another apparatus.

A video RAM (VRAM) 105 expands an image displayed on the window of a display unit 106 that indicates the operating status of the computer system, and controls this display. The display unit 106 is, for example, a CRT display. Although the VRAM and CRT are not essential in the case of a document processing apparatus, provision of these is necessary in cases where page information is presented on the display after layout processing.

A controller (KBC) 107 controls an input signal from an external input unit 108. The external input unit 108 accepts an operation performed by the user of the computer system in order to operate the system. The external input unit 108 includes a keyboard (KB), etc.

A storage device 109 is, for example, a hard-disk drive (HDD). The HDD 109 is used to store an application program and data such as image information. An application program in this embodiment refers to a software program for executing document processing and layout processing, which constitute this embodiment. An external input/output unit 110 such as a floppy-disk drive (FDD) is for receiving a removable storage medium and reads the above-mentioned application program from the storage medium. An application program and various data stored on the hard-disk drive 109 can be used upon being stored on the unit 110, assumed to be a floppy-disk drive.

An input/output bus (address bus, data bus and control bus) 111 is for connecting the units mentioned above.

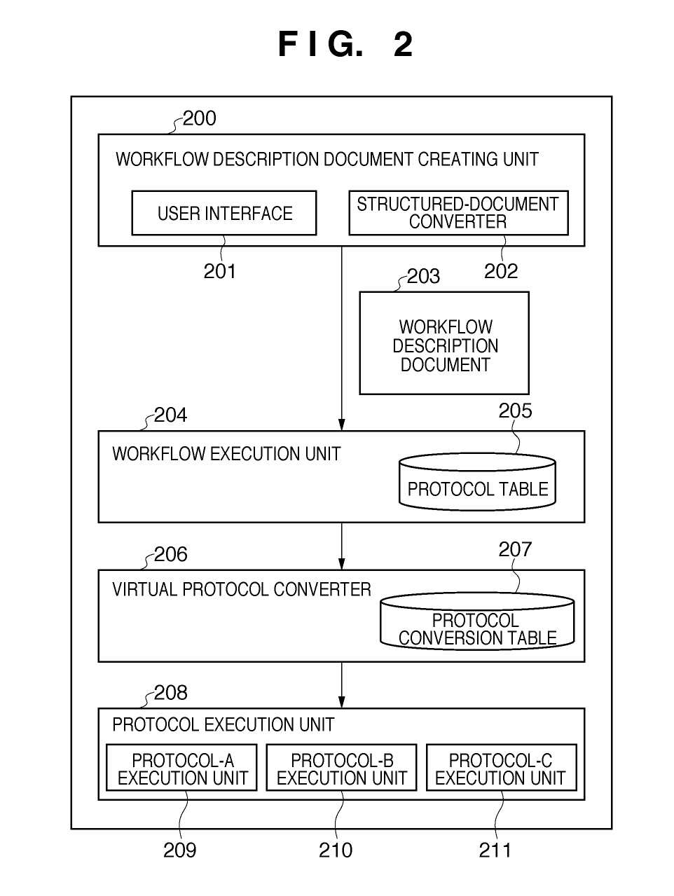

Next, application modules executed by the workflow processing apparatus shown in FIG. 1 will be described with reference to FIG. 2. It should be noted that the function of an application module is implemented by reading the program of software recorded on a storage medium such as the hard-disk drive 109 to the RAM 102 and executing the program by the CPU 101.

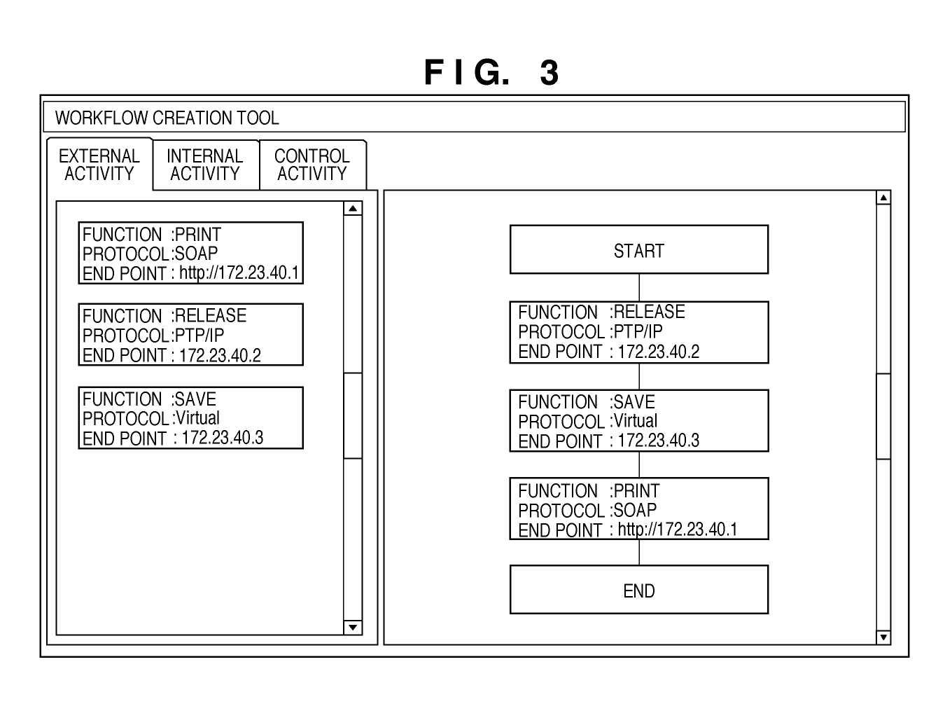

A unit 200 in FIG. 2 is for creating a workflow description document 203 and includes a user interface 201 and a structured-document converter 202. The user interface 201 displays a user interface of the kind shown in FIG. 3 on the CRT 106 and is capable of creating a workflow in a simple manner.

FIG. 3 is a diagram illustrating an example of a user interface window in this embodiment. As shown in FIG. 3, a workflow can be created merely by pasting and associating activities on a panel by drag-and-drop. Activity is a unit of processing in a workflow. In the example shown in FIG. 3, external activities, internal activities and control activities have been set as activities. FIG. 3 shows that functions, namely shoot a picture (release), save and print, of external activities have been pasted and associated on the panel on the right side of the window.

Further, in order to indicate that an activity is one that is based upon a virtual protocol, “Virtual” is set as the protocol attribute of the activity. FIG. 3 shows that an actual protocol used when the “Save” function is executed has not been decided.

It should be noted that a virtual protocol is one that abstractly expresses functions (concepts and operating methods thereof) common to a plurality of protocols when devices or services are linked. In the case of a printer, for example, it expresses a print function.

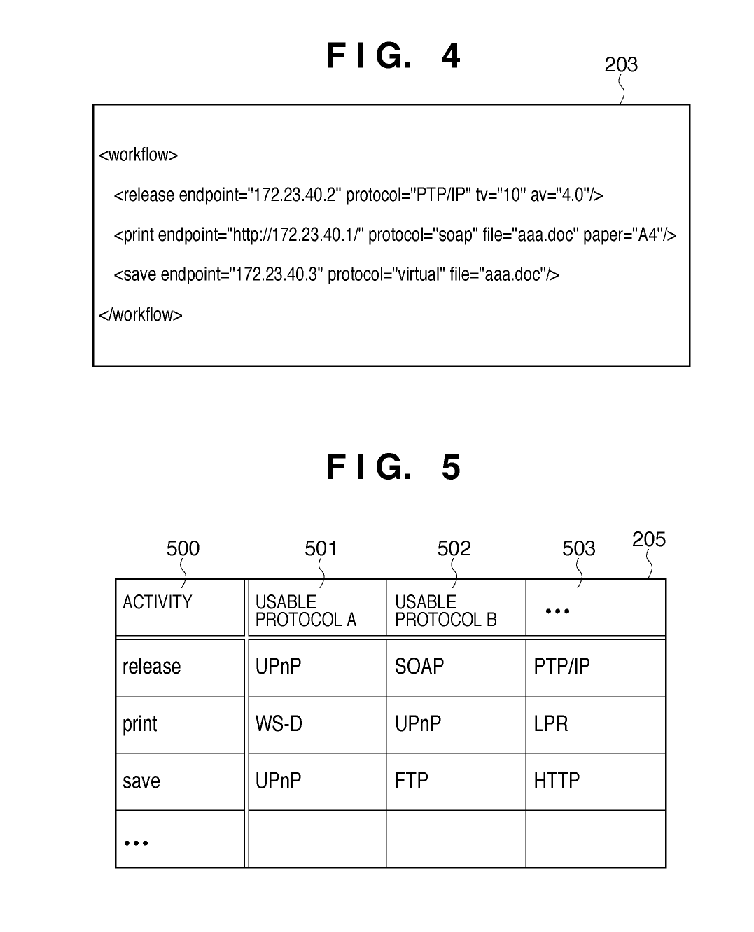

With reference again to FIG. 2, the structured-document converter 202 of the workflow description document creating unit 200 converts a workflow to a workflow description document 203, which is a structured document described in XML (eXtensible Markup Language), shown in FIG. 4.

FIG. 4 is a diagram illustrating an example of the workflow description document 203 obtained by the conversion performed by the structured-document converter 202 in this embodiment. With regard to the virtual protocol for which the protocol attribute shown in FIG. 3 has been set to “Virtual”, the “protocol” attribute of the “save” element is set as “virtual” in the XML description of FIG. 4 as well. That is, here “save” is a command indicating that the save function is executed in the virtual protocol. This indicates that an actual protocol used when the save function is executed has not been decided.

With reference again to FIG. 2, a workflow execution unit 204 reads in and executes the workflow description document 203 created by the workflow description document creating unit 200. The workflow execution unit 204 includes a protocol table 205 for managing an actual protocol corresponding to every virtual protocol.

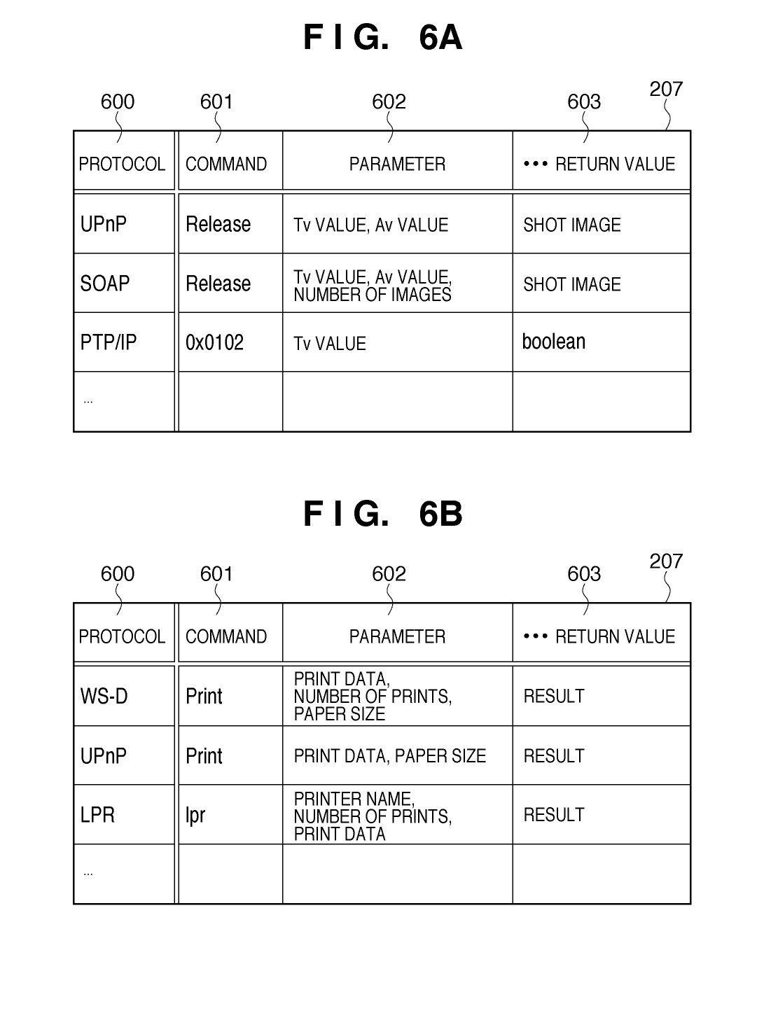

FIG. 5 is a diagram illustrating an example of the protocol table 205 contained in the workflow execution unit 204 in this embodiment. The protocol table 205 shown in FIG. 5 is mapped to a plurality of actual protocols for every activity (command) 500 in a virtual protocol and is managed according to order of priority. A usable protocol A 501 has the highest priority and is followed successively by usable protocols B 502, . . . 503. For example, in a case where an activity (command) 500 is release (shoot a picture), the protocol having the highest priority is UPnP, followed successively by SOAP, PTP and IP. In addition, actual protocols used when executing other activities such as save are similarly managed. “Save” in FIG. 4 is executed by of the protocols UPnP, FTP or HTTP.

In a case where an activity to be executed has been defined by a virtual protocol, the workflow execution unit 204 determines which protocol should be used based upon the protocol table shown in FIG. 5. It should be noted that the content of the protocol table depicted in FIG. 5 is one example and the combinations of activities 500 and usable protocol A501 and usable protocols B 502, . . . 503 are not limited to those shown. Further, “ . . . 503” in FIG. 5 means that there is no limitation upon the number of priority rankings.

With reference again to FIG. 2, a virtual protocol converter 206 executes processing for conversion between a virtual protocol and an actual protocol. The virtual protocol converter 206 includes a protocol conversion table 207 that manages the corresponding relationship between virtual protocol and actual protocol commands.

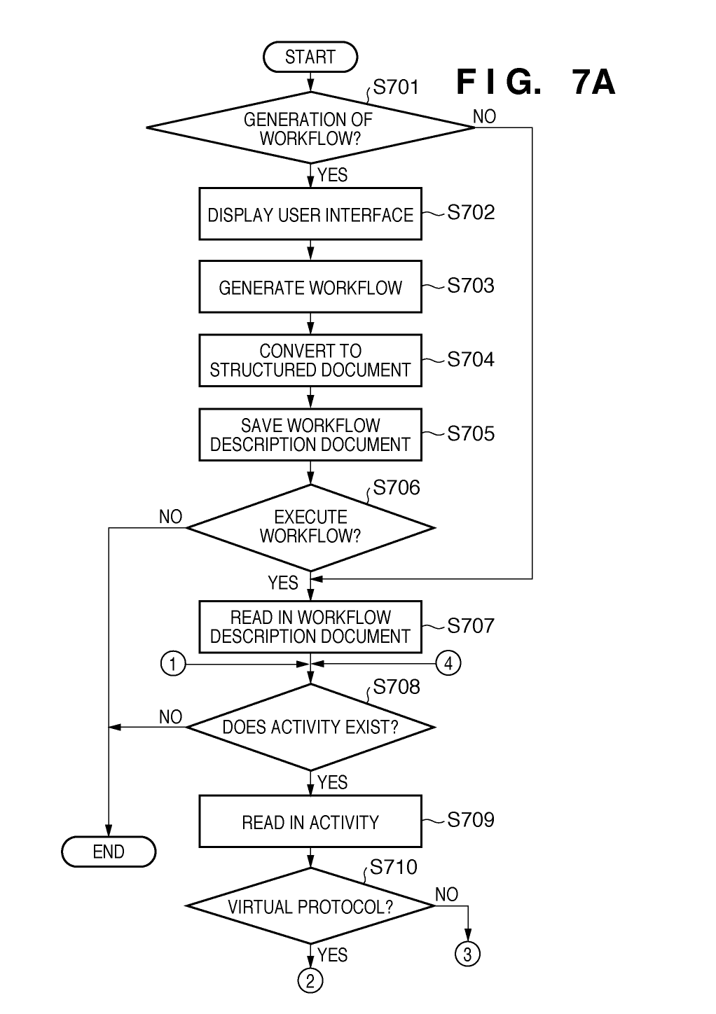

FIGS. 6A and 6B are diagrams illustrating examples of the protocol conversion table 207 contained in the virtual protocol converter 206 in this embodiment. The protocol conversion table 207 manages a command 601, parameter 602 and return value 603 for every protocol 600. FIG. 6A is an example in which an activity (command) in a virtual protocol is “Release” (a command to execute a shoot function), and FIG. 6B is an example in which an activity in a virtual protocol is “Print” (a command to execute a print function). In a case where the protocol 600 is UPnP in FIG. 6A, the command 601 is release and indicates that a Tv value and Av value are required as parameters 602. Further, this command indicates that a shot image is sent back as the return value 603, which is the result of execution.

The virtual protocol converter 206 executes the conversion of a command from that of virtual protocol to that of actual protocol based upon the protocol conversion table 207. More specifically, if the activity “print” has been defined by the virtual protocol, then the virtual protocol converter 206 makes the conversion to the command of the actual protocol based upon the protocol conversion table 207 for “print” (FIG. 6B). It should be noted that the protocols 600, commands 601, parameters 602 and values of the return values 603 are examples and are not limited to those shown.

With reference again to FIG. 2, a protocol execution unit 208 executes processing using actual protocols. As illustrated in FIG. 2, the protocol execution unit 208 includes a protocol-A execution unit 209, a protocol-B execution unit 210 and a protocol-C execution unit 211, which are equipped with actual protocols. Although FIG. 2 illustrates an arrangement that includes the protocol-A execution unit 209, protocol-B execution unit 210 and protocol-C execution unit 211, the number of separate protocol execution units contained is not limited to three. The protocol-A execution unit 209, protocol-B execution unit 210 and protocol-C execution unit 211 execute the actual protocols UPnP, SOAP and PTP/IP, respectively, by way of example.

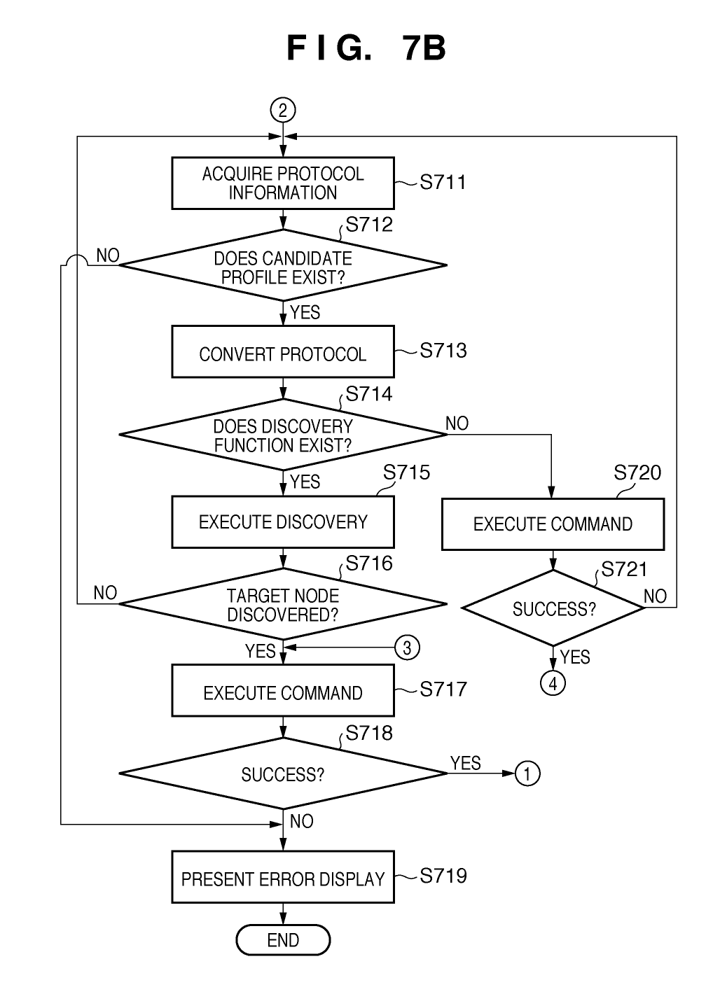

Reference will now be had to FIGS. 7A to 9 to describe a method of generating a workflow that includes a virtual protocol and processing this virtual protocol by using the workflow processing apparatus.

FIGS. 7A and 7B are flowcharts illustrating virtual protocol processing in this embodiment. After processing starts, it is determined in step S701 which of workflow generation or workflow execution has been selected. If workflow execution has been selected, control proceeds to step S707. The processing in step S707 will be described later.

If the result of the determination made in step S701 is that workflow generation has been selected, then control proceeds to step S702. Here the user interface 201 displays the user interface window (workflow creation tool) shown in FIG. 3.

Next, in step S703, a workflow is generated by a method of dragging and dropping activities onto the panel on the right side of this user interface window and associating the activities on the right side of the window. In FIG. 3, release, save and print activities are dragged and dropped between start and end, and lines are used to connect start and release, release and save, save and print and print and end. When generation of the workflow is completed, control proceeds to step S704, where the structured-document converter 202 converts the workflow generated in step S703 to the workflow description document 203, which is the structured document shown in FIG. 4, described in XML.

Next, in step S705, the workflow description document generated in steps S703 and S704 is saved on the hard-disk drive 109 or floppy-disk drive 110. Next, in step S706, it is determined whether the workflow description document saved in step S705 is to be executed. If the result of the determination is that execution of the workflow description document has not been designated, then processing exited. However, if execution of the workflow description document has been designated, then control proceeds to step S707, where the workflow execution unit 204 reads in the workflow description document. It should be noted that the workflow description document specified is read in from the hard-disk drive 109 or floppy-disk drive 110 in step S707 also in a case where workflow execution has been selected in step S701.

Next, in step S708, it is determined whether an activity to be executed exists in the workflow description document. If no activity to be executed exists, that is, if all activities have been executed, then processing is exited. However, if an activity to be executed exists, control proceeds to step S709 and the activity to be executed is read in. In the example of FIG. 4, the activity “release” is read in first. As will be described later, after the activity “release” is executed, the activity “print” is executed and then the activity “save” is executed.

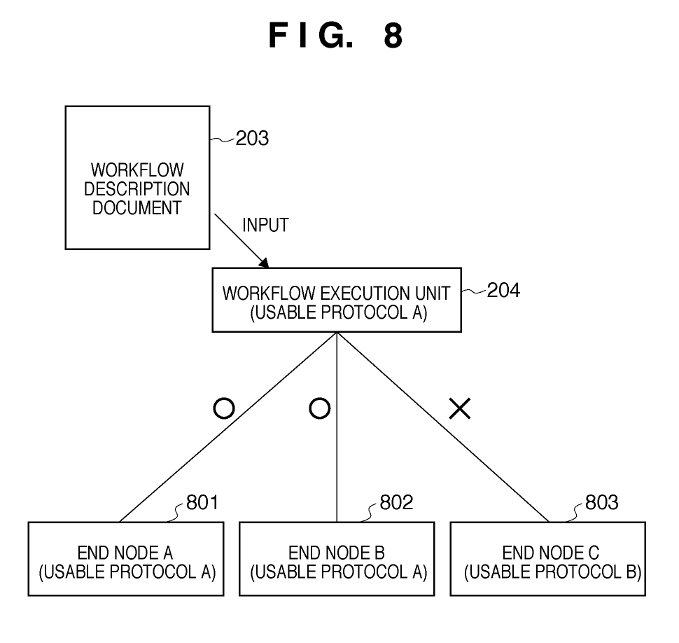

Next, in step S710, it is determined whether the activity to be executed has been defined by a virtual protocol. This determination is made based upon whether “Virtual” has been set as the protocol attribute of this activity. If it is determined here that the activity has been defined by an actual protocol and not by a virtual protocol, then control proceeds to step S717. If protocol A, which is an actual protocol, has been set as the protocol attribute of the activity, the following result is obtained: As shown in FIG. 8, the protocol-A execution unit 209 executes the command at target end nodes A 801, B 802 and C 803, and therefore failure occurs at end node C 803, where the usable protocol is different.

On the other hand, if it is determined in step S710 that the activity has been defined by a virtual protocol, control proceeds to step S711. Here the protocol applicable to this activity is acquired from the protocol table 205 shown in FIG. 5. If the activity is “release”, first UPnP is acquired as the usable protocol. Then, in step S712, it is determined whether an actual protocol to be applied to this activity exists. If the result of the determination is that there is no applicable actual protocol or that all protocols have already been checked in accordance with the order of priority, then control proceeds to step S719. Here an error message to the effect that the activity could not be executed is displayed. Processing is then exited.

However, if it is determined in step S712 that an applicable actual protocol exists, then control proceeds to step S713. Here the virtual protocol converter 206 acquires the information of the actual protocols, such as the commands, parameters and return values in the protocols of the activity, from the protocol conversion table 207 shown in FIG. 6A or 6B and performs the protocol conversion. If the activity read in step S709 is the “release” command of the virtual protocol, then the virtual protocol converter 206 acquires information such as the command, parameters and return values of UPnP, which is the actual protocol having the first (highest) order of priority.

Next, in step S714, it is determined whether this protocol has a discovery function. If it is determined in step S714 that this protocol does not have a discovery function, control proceeds to step S720, where the protocol execution unit 208 executes the command converted in step S713. Whether the executed command has succeeded or not is determined in step S721. If it is determined that the execution of the command has succeeded, control returns to step S708 and the next activity is executed. If execution of the command has failed, however, then it is determined that the target end node cannot use this protocol and control returns to step S711. Here the protocol information of the next highest order of priority is acquired and the processing of step S715 is executed.

On the other hand, if it is determined in step S714 that the protocol has a discovery function, then control proceeds to step S715. Here discovery is executed using the discovery function of this protocol. Then, in step S716, it is determined whether the result of discovery executed in step S715 is that a target end node has been discovered. If the result of the determination is that a target end node has not been discovered, then it is determined that the target end node cannot use this protocol. Control then returns to step S711, the protocol information having the next highest order of priority is acquired and the processing of step S715 is executed. In a case where the activity is “release”, SOAP is acquired next if a target end node is not discovered using the discovery function possessed by UPnP acquired initially as the usable protocol.

On the other hand, if a target end node is discovered in step S716, then control proceeds to step S717 and the command converted in step S713 is executed. In other words, if the protocol A acquired in step S711 has a discovery function, then the protocol-A execution unit 209 executes discovery based upon protocol A. As a result, the protocol-A execution unit 209 determines that the target end nodes A 901 and B 902 are capable of using the protocol A and executes the command of protocol A with respect to the end nodes A and B discovered by protocol A.

Next, in step S718, it is determined whether the command executed in step S717 succeeded or not. If success is determined, control returns to step S708 and the next activity is executed. In the example of FIG. 4, the “print” activity is executed after the “release” activity.

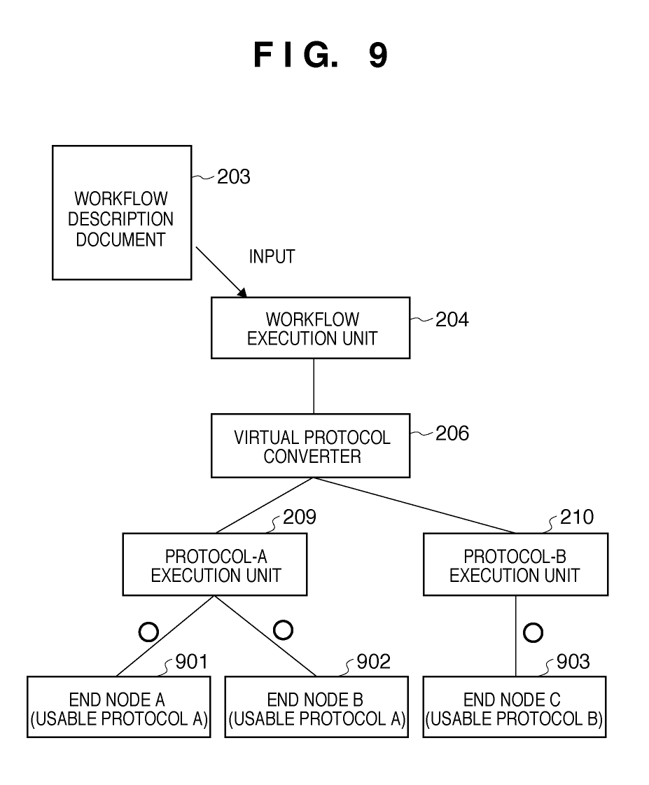

Another embodiment is illustrated in FIG. 9. Specifically, if it is determined in step S718 or S721 that the command based upon protocol A, which is an actual protocol having the first (highest) order of priority, has succeeded, then a command based upon the actual protocol having the second order of priority is further executed. By adopting this arrangement, execution of commands with respect to end node A 901 and end node B 902 that use actual protocol A and with respect to end node C that uses actual protocol B succeeds.

On the other hand, if failure is determined in step S718, then control proceeds to step S719, an error message to the effect that execution of the activity failed is displayed and then this processing is exited.

In accordance with this embodiment, a workflow can be described independently of protocol and it is possible to convert to a usable protocol at the time of workflow execution. As a result, a network device equipped with various protocols can be incorporated in the workflow.

The present invention may be applied to a system constituted by a plurality of devices (e.g., a host computer, interface, reader, printer, etc.) or to an apparatus comprising a single device (e.g., a copier or facsimile machine, etc.).

Furthermore, it goes without saying that the object of the invention is attained also by supplying a recording medium storing the program codes of the software for performing the functions of the foregoing embodiments to a system or an apparatus, reading the program codes from the recording medium using a computer (e.g., a CPU or MPU) of the system or apparatus, and then executing the program codes.

In this case, the program codes read from the recording medium implement the novel functions of the embodiments and the recording medium storing the program codes constitutes the invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-147070, filed Jun. 4, 2008, which is hereby incorporated by reference herein in its entirety.

What is claimed is:

1. A workflow processing apparatus comprising:
an input unit that inputs a workflow description document in which processes to be executed by the workflow have been described;
a reading unit that reads data, which specifies a protocol for executing a process, from said storage unit; and
an execution unit that executes a process, for which a specific protocol used at the time of execution has not been described in the workflow description document, using the protocol specified by the data read by the reading unit.

2. The apparatus according to claim 1, wherein the execution unit executes a process, for which the specific protocol used at the time of execution has been described in the workflow description document, using the specific protocol.

3. The apparatus according to claim 1, wherein the reading unit reads a command, which is for executing the process in the protocol, from the storage unit, and said execution unit executes the command using the protocol.

4. The apparatus according to claim 1, wherein the reading unit reads data specifying a plurality of protocols for executing processes, and the execution unit executes a process corresponding to a function common to the plurality of protocols, the process being one for which the specific protocol has not been described in the workflow description document, the processing being executed using one of the plurality of protocols specified by the data that has been read from said storage unit.

5. The apparatus according to claim 1, wherein the input unit has:
a graphic interface generating unit that generates a graphic interface for selecting a process to be executed; and
a workflow description document generating unit that generates a workflow description document in which the process selected by the graphic interface has been described;
wherein the input unit inputs the workflow description document generated by the workflow description document generating unit.

6. A workflow processing method for processing a workflow, comprising:
an input step of inputting a workflow description document in which processes to be executed by the workflow have been described;
a reading step of reading data, which specifies a protocol for executing a process, from a storage unit; and
an execution step of executing a process, for which a specific protocol used at the time of execution has not been described in the workflow description document, using the protocol specified by the read data.

7. The method according to claim 6, wherein the execution step executes a process, for which the specific protocol used at the time of execution has been described in the workflow description document, using the specific protocol.

8. The method according to claim 6, wherein the reading step reads a command, which is for executing the process in the protocol, from the storage unit, and said execution step executes the command using the protocol.

9. The method according to claim 6, wherein the reading step reads data specifying a plurality of protocols for executing processes, and the execution step executes a process corresponding to a function common to the plurality of protocols, the process being one for which the specific protocol has not been described in the workflow description document, the processing being executed using one of the plurality of protocols specified by the data that has been read from the storage unit.

10. The method according to claim 6, wherein the input step has:
a graphic interface generating step of generating a graphic interface for selecting a process to be executed; and
a workflow description document generating step of generating a workflow description document in which the process selected by the graphic interface has been described;
wherein the input step inputs the workflow description document generated at the workflow description document generating step.

11. A storage medium storing a computer program for processing a workflow, the program comprising:
an input step of inputting a workflow description document in which processes to be executed by the workflow have been described;
a reading step of reading data, which specifies a protocol for executing a process, from storage unit; and
an execution step of executing a process, for which a specific protocol used at the time of execution has not been described in the workflow description document, using the protocol specified by the read data.

12. The medium according to claim 11, wherein the execution step executes a process, for which the specific protocol used at the time of execution has been described in the workflow description document, using the specific protocol.

13. The medium according to claim 11, wherein the reading step reads a command, which is for executing the process in the protocol, from the storage unit, and the execution step executes the command using the protocol.

14. The medium according to claim 11, wherein the reading step reads data specifying a plurality of protocols for executing processes, and the execution step executes a process corresponding to a function common to the plurality of protocols, the process being one for which the specific protocol has not been described in the workflow description document, the processing being executed using one of the plurality of protocols specified by the data that has been read from the storage unit.

15. The medium according to claim 11, wherein the input step has:
a graphic interface generating step of generating a graphic interface for selecting a process to be executed; and
a workflow description document generating step of generating a workflow description document in which the process selected by the graphic interface has been described;
wherein said input step inputs the workflow description document generated at said workflow description document generating step.
